(19) United States
(12) Patent Application Publication
(10) Pub. No.: US 2005/0222906 A1
(43) Pub. Date: Oct. 6, 2005

(54) System and method of targeted marketing

(76) Inventor: Timothy Tianyi Chen, Athens, GA (US)

Correspondence Address: REED SMITH LLP, 2500 One Liberty Place, 1650 Market Street, Philadelphia, PA, 19103-7301, US

(21) Appl. No.: 11/053,741

(22) Filed: Feb. 8, 2005

Related U.S. Application Data
(63) Continuation-in-part of application No. 10/072,647, filed on Feb. 6, 2002.

(51) Int. Cl. G06F 17/60

(52) U.S. Cl. 705/14

(57) ABSTRACT

A method for providing at least one targeted local marketing program and for measuring the effectiveness of the at least one targeted local marketing program is disclosed. The method includes generating at least one targeted message in accordance with instructions of at least one retailer, forwarding at least one targeted message to a plurality of select customers, and monitoring responses from the plurality of select customers via an identification methodology. The monitoring allows for a determination of the effectiveness of the at least one marketing program, where the targeted messages attract customers to retailers by targeting the plurality of select customers with incentives.

### RELATED APPLICATIONS

This application is a continuation-in-part of U.S. patent application Ser. No. 10/072,647, filed Feb. 6, 2002, the entire disclosure of which is incorporated by reference herein as if being set forth in its entirety.

### FIELD OF THE INVENTION

The present invention relates to marketing systems and methods, and, more particularly, to consumer specific, localized market data generation and methods of maximizing such data for increased local sales.

### BACKGROUND OF THE INVENTION

The internet has provided many new opportunities in retail, as can be evidenced by the presence of online retailers and auctioneers. However, while making purchases online provides convenient options to consumers, such as through auction websites or online retailers that send products to the consumer via mail, the consumer still has many needs which can be best met by local brick and mortar retailers. For example, the restaurant industry provides an ambiance and entertainment features not available to food delivery services. In another example, the consumer may wish to buy perfumes or other fragrant personal items, which can only be sampled by entering the store and sampling the products. Thus, there exists a significant impediment to a customer purchase of items on-line in instances wherein the item cannot be inspected beforehand, or wherein the customer does not have prior knowledge of the item. Naturally, this impediment does not exist when a customer enters a conventional store, examines merchandise for sale, and purchases the item based on the examination.

The internet has also gone through many stages in the development of online advertising and marketing. Traditional advertising has employed a “one size fits all” brand awareness approach. In reality, consumer purchasing behaviors are driven and influenced by various factors such as price, quantity, quality, novelty, repetition, brand and impulse. Current methods of advertising do not establish a one-to-one relationship with consumers to take advantage of motivating traits that drive them to the point of sale. Rather, correlated demographics are used to predict consumer behavior. However, subsets of individuals with identical demographic factors can exhibit actual behaviors that are significantly different from one another. Therefore, true behavior analysis through actual consumer purchases would serve as a much better predictor of likelihood to purchase than demographics characteristics.

Current models of internet advertising, such as those using banners on websites, or pop-up browser windows, have not typically been successful. This may be attributed to the fact that once the novelty of using the advertisement website fades, there is nothing to remind consumers to return for information on additional bargains, savings or package deals.

Part of the difficulties for retailers using the internet as a marketing tool is that the retailer is limited in how it can reach its customers. First, it can send information in the form of email to customize personalized advertisements towards consumers. This system, often described as “spam” email, has mostly been treated as excessive junk materials. Consumers often become irritated by this strategy and it thus may actually create a negative effect on the consumer. Further, it becomes difficult to differentiate emails that create value and those that do not. Another internet marketing strategy involves the development of websites specific to a particular retailer. While this sort of promotion can be very effective, the consumer must either know how to directly reach that retailer's website, or, more commonly, rely on a search engine to find what they are looking for. Further, the costs related to website development and maintenance can be very expensive, and without an effective way to bring a consumer to the website, the costs and effort of creating a website can be wasteful.

Internet searching, while having made great strides on broad, global searches, remains primitive to the consumer who wants to search within his or her local region. This, unfortunately, makes a particular local retailer's website ineffective, because the consumer cannot reach the website. Therefore, a need exists for a better conduit between the local retailer and the consumer over the internet.

Alternatively, local retailers have used coupons as a way to bring customers into their establishments. While coupons may be trackable and may show actual driving of sales to the business establishment by an advertisement, those consumers who use coupons often will not become regular customers, because they only go to a retailer in the event of a coupon offer. Further, large volumes of coupons and coupon-type consumers may degrade the image a business may want to portray. Therefore, because coupons are only used by a certain subset of the consumer population, and are often used repetitiously, their effectiveness is limited. Further still, coupons may require newspaper, television, radio, magazine, or stand-alone store display investments by a retailer. Coupons may also have expiration dates, and thus may require additional investment in paper printing to re-initiate discounts, thereby decreasing retailer efficiencies. Additionally, coupons require business employees to review additional paperwork while processing sales transactions, thereby decreasing employee efficiency and increasing customer inconvenience.

Therefore, a need exists to link the convenience of a conventional brick and mortar store in an effective advertisement program that provides measurable marketing for local retailers, and to dispense savings to, and increase loyalty from, consumers without the use of physical coupons.

### SUMMARY OF THE INVENTION

The present invention discloses a method for providing at least one targeted local marketing program and for measuring the effectiveness of the at least one targeted local marketing program. The method includes generating at least one targeted message in accordance with instructions of at least one retailer, forwarding at least one targeted message to a plurality of select customers, and monitoring responses from the plurality of select customers via an identification methodology. The monitoring allows for a determination of the effectiveness of the at least one marketing program, where the targeted messages attract customers to retailers by targeting the plurality of select customers with incentives.

The present invention also discloses a method of providing targeted incentives to at least one consumer. The method includes providing a one-click coupon for at least one specific product to at least one select consumer based on a behavioral purchasing rating system and instructions from at least one retailer, updating the at least one select customer account based on the at least one select customer interaction with the provided on-click coupon, discounting the at least one specific product when the at least one select customer purchases the product at the at least one retailer upon the customer providing account information to the retailer.

The present invention further discloses a method for providing a loyalty based reward program. The method includes establishing at least one loyalty program containing at least one customer and one retailer, providing at least one tier within each of the at least one loyalty program, where each tier provides a unique value within the loyalty reward program, accounting for predetermined values of loyalty points based on products purchased according to the tier system, and providing at least one point of retail for redemption of the accounted loyalty points.

The present invention also discloses a system for locally presenting information generated at a remote administrator. The system includes a local display unit, having associated therewith at least one memory cache, a plurality of information associated with a memory unit at the remote administrator; and a selector, where, based on a location of the local display unit, ones of the plurality of information are selected from the memory unit at the remote administrator for exclusion from forwarding from the memory unit to the cache, where ones of the plurality of information for inclusion from forwarding are selected by the selector and are forwarded, by the selector, from the memory unit to the cache for assignment to predetermined frames of the cache for display on the local display unit in accordance with an order of the predetermined frames.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts:

FIG. 1 is a block diagram illustrating a system for providing a targeted local marketing program;

FIG. 2 is a flow diagram illustrating a method of advertising, and of measuring the effectiveness of advertising;

FIG. 3 is a screenshot of an exemplary embodiment of the present invention;

FIG. 4a is a diagram of exemplary behavioral trait categories of a population of consumers;

FIG. 4b is a diagram of a segregation of a population of consumers within exemplary behavioral trait categories;

FIG. 4c is a diagram of business targeting of particular behavioral trait categories of a population of consumers;

FIG. 5 is an exemplary scaling system of behavioral trait categories;

FIG. 6 is an exemplary statistical analysis of a behavioral trait scaling system;

FIG. 7 is an exemplary analysis of targeted behavior trait groups;

FIG. 8 is an exemplary analysis of locational purchasing behaviors;

FIG. 9 is an exemplary targeting strategy using promotional material; and

FIG. 10 is an exemplary analysis of a shared loyalty program.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in typical internet system or marketing system and method. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

The present invention may serve as a mechanism to increase traffic towards local retail establishments, and loyalty to local retail establishments or products. For example, the invention may work with existing loyalty programs because it may promote a special discount for a particular product or service to drive consumer traffic into the retailer's establishment. Existing loyalty programs typically attempt to convince consumers to purchase primary items using minor discounts on secondary items for an overall enhanced shopping experience.

For example, two local retailers, store X and store Y, may compete for the same group of consumers. While store X attracts consumers because it is known as the low cost leader, store Y attracts its client base using a frequent shopper card, which offers different specials every week. The present invention may allow a retailer, such as store Y, to attract consumers into their establishment while minimizing the number of promotions to do so. For example, should store Y decide to promote product A with the present invention at a lower cost than sold at store X, consumers who normally make purchases at store X may be targeted and may come to store Y for their set of purchases. Studies have shown that consumers purchase more items in addition to the promotional items once they are driven to the point of sale. According to this model of consumer behavior, in addition to the promotion, the consumer may also purchase products B, C and D from store Y at prices slightly higher than those of store X. As the sum of the greater profits from the sale of products B, C and D may be greater than the decrease in profits of discounted product A, store Y may successfully take market share from store X and increase margins at the same time. The present invention also may provide a retailer with the ability to expedite the sale of products that may be overstocked, seasonal and/or perishable using the promotional systems of the present invention. It should be obvious to those skilled in the art that any existing promotional system may be incorporated or used in combination with the present invention, such that promotions may be utilized to maximize profitability and consumer loyalty with a particular retailer.

The present invention may also provide retailers with the ability to offer promotions to all consumers, or only to consumers that fit specific purchasing profile trends. Thus, the present invention may allow a retailer to target specific types of consumers according to profiles of their actual purchases, and not simply by demographic statistics that merely predict what a typical consumer in a given category may want to purchase. This type of focused marketing may provide the retailer with more confidence that their marketing efforts will provide a greater success rate in increasing consumer traffic, of the desired customer type, to their establishments.

Because every person and every business may have a different opinion on what is considered “local” in relationship to them, the present invention may provide businesses the ability to define their own marketable boundaries. Consequently, consumers, through their purchasing behavior, may dictate on an individual level what they consider their “local” shopping environment. Therefore, what may be considered “local” to a consumer or business may be anywhere from a surrounding city block, to a county or zip code region, or even state or nationwide coverage. Businesses may thus target consumers within whatever regions they consider to be local to them.

The present invention may provide this one-to-one relationship not only in advertising but likewise in assessing consumer loyalty, and may enable a company to have real time data on individualized purchasing patterns for specific consumers, which may then reveal to the retailer when a consumer abandons usage of, or changes preferences for, particular products. For example, after a retailer promotes a product with the present invention, the retailer may obtain tracking data on a particular consumer, such as via the use of a uniquely identifying saver or program card assigned to a targeted consumer, related to the promoted product when that consumer actually purchases the product. Consumer personal information may be hidden from the retailer through the assignment of a unique identifier. The retailer may then determine whether the consumer returns at a later time to purchase the same product, other products or any combination of purchased products from that retailer. Businesses may also have the ability to identify consumers who prefer particular products through past purchasing behaviors, as seen through the provided tracking data, to allow for an engagement in more targeted promotions and expediting of the movement of merchandise. Thus, the present invention may provide traceable data to retailers for determining the effectiveness of their individual promotions and their ability to build and maintain loyal consumers. Such data may provide retailers with the ability to strategically plan for future sales.

Further, the present invention may provide market tracking data at a significantly lower cost than conventional market analysis systems, due to its timely electronic information collection system. Because advertising schemes may be localized, businesses may determine which market they wish to target and may compare results from different markets. A business may also promote different prototypes or versions of products simultaneously to gauge consumer preference before settling on the final parameters of the product. Periodic surveys may also be available through the present invention to solicit feedback data. It should be evident to those skilled in the art that any existing market analysis model may be incorporated into or used in combination with the present invention to enhance the quality of a market analysis system.

The present invention may also provide an inexpensive way to establish a loyalty program to track and advertise to consumers. Customer loyalty programs may be generated, allowing the business to award consumers exhibiting certain purchasing behaviors. It should be evident to those skilled in the art that any existing loyalty program may be incorporated or used in combination with the present invention, as well as a competitive multiple shared program, as describe in greater detail below. The benefits of a loyalty program when used in conjunction with traceable data of consumer purchases are many. For example, smaller businesses tend not to use traditional loyalty programs because of their high costs. Also, the intended audience of smaller business advertising is usually much smaller than what traditional advertising mediums cover. By tracking loyalty program data of consumers within a certain radius of the establishment, management may focus advertising and relationship-building more efficiently within the community to enhance the reputation of a business, and at a significantly lower cost than other loyalty or advertising systems. Management reports may be generated by software systems of the present invention to highlight the business's market share, performance and customer loyalty in comparison to statistics of the industry, or any other relevant data.

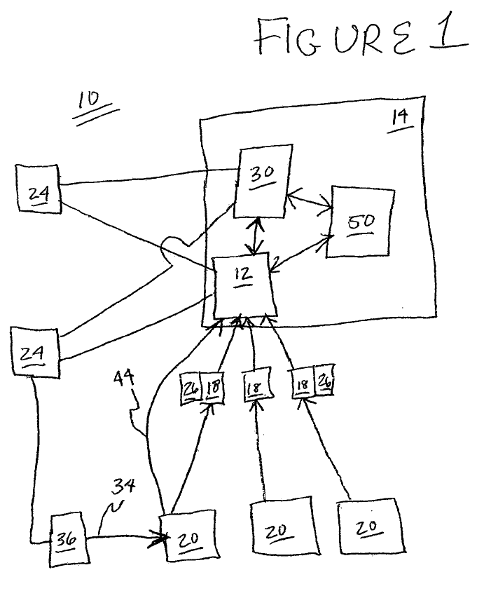

FIG. 1 is a block diagram illustrating a system 10 for providing a targeted local marketing program. System 10 may include targeted messages 12, such as e-mail messages, generated at a program administrator 14, wherein the messages 12 are generated in accordance with instructions 18 of at least one retailer 20, and wherein the targeted messages 12 are forwarded to a plurality of select customers 24, such as those customers that express a willingness to be in the program, wherein the select plurality 24 is determined based upon the target criteria 26 of at least one retailer 20. The select plurality of consumers 24 may respond to the messages 12, and/or may interact with the retailers 20, and/or may register for the program by initiating a profile 30, and/or may vary profile information, at the program administrator 14. The select customers 24 may have responses 34 to the targeted messages recorded, and may have profile information 30 varied, at the program administrator 14, via a validation card or other identification methodology, such as a program or “saver” card 36, which saver card 36 is in communication with the program administrator 14. The identity of customers 24 may be kept confidential and not revealed to retailers 20, as retailers 20 may know the consumer simply as a unique identification number. The present invention may attract customers to businesses by targeting select customers with discounts, sales, promotions, and other incentives. Additionally, consumers may actively select promotions from retailers and add such promotions to their accounts.

The targeted messages 12 may be, for example, emails, telephone calls, internet messages, such as instant messages or “ping”s, mobile telephone messages, including short messaging, PDA messaging, or messages included in communication overhead, such as the overhead associated with television or cellular telephone communications. E-mail advertisements, for example, are highly selectable as to the desired recipient, easy to generate, and low in cost. Targeted messages 12 improve name recognition for businesses 20 in the program. However, it is preferable that the present invention not allow for “junk email”, wherein customers 24 are overwhelmed with targeted, or non-targeted, messages. The blockage of junk e-mail may result in less deletion of targeted advertisements by customers.

The program administrator 14 generates the targeted messages 12, which targeted messages may include invitations to a web page at the program administrator 14. The program administrator 14 may be, for example, a server, such as an internet server, and preferably includes accessibility to internet users, such as through the web page on the program administrator 14. The messages 12 are generated in accordance with instructions 18 of at least one retailer participating in the program, or of the administrator 14. Content may be varied by the retailer 20, by the administrator 14, or by the administrator at the instruction of the retailer. The retailer 20 may forward the instructions 18 for the formulation of advertising, and the criteria for desired target audience for the advertisement or invitation 12, to the program administrator 14. The retailer 20 may additionally forward the content of the advertisement 12 to the administrator 14, or the program administrator 14 may generate the advertisement 12 in accordance with the information received from the retailer. It is preferable that the administrator serve to interface the advertisements to the consumers.

In order to maintain interest of consumers 24 in the program, new advertisements 12 may preferably be generated frequently. For example, the interval of receiving new advertisements via e-mail may be selected by a customer in the customer profile, by the retailer in the advertisement submission, or by the program administrator, at every day, every other day, specific days of the week, once a week, once a month, at specific times of the month, or at specific times of the year.

The program administrator 14 forwards the generated advertisement 12 to a plurality of select targeted customers 24, wherein the select plurality 24 is determined based upon a comparison of the target criteria in the instructions 18 from at least one retailer 20 to the accumulated profile information, or “target history”, of a plurality of the customers 24. Thus, the target criteria 18 may include the buying history of the consumer 24. The recipients of the targeted message 12 are identified by the program administrator 14 by searching for program participants, i.e. customers 24, that meet the target criteria 18 according to the profile information 30 of those customers 24 entered at the program administrator 14.

The program administrator 14 may allow for the consumers 24 to respond to the messages 12, such as by making a purchase online through the program administrator 14, and/or may allow for interaction with the retailers 20, such as by providing hyperlinks to the retailers 20, and/or may allow for registration of the consumer 24 into the program by initiating a consumer profile 30, and/or may allow for a user to vary profile information 30. These interactions may, for example, be provided over an internet interface, such as the web page, at the program administrator 14. Further, profile information 30 may, for example, be maintained at the program administrator 14 in at least one database, such as at least one relational database.

Additionally, responses 34 to the advertisements occurring at the retailer 20 providing the targeted advertisement 12 may be recorded at the program administrator 14, such as by the use of a saver card 36. The saver card 36 may include an identification of the customer 24 associated therewith, such as a magnetic strip, bar code, RFID, or identification number, and that customer identification may be associated with the profile of that customer at the program administrator. Thus, the saver card 36 may be used at the participating retailer 20 to identify, to the program administrator 14, that a targeted customer 24 has engaged in the behavior desired to be elicited by the targeted advertisement 12, such as by entry of the identification of the customer 24 at the retailer 20, by a swipe or scan of the saver card, or by a like data entry, such as by manual entry or credit card swipe, by the retailer 20. This identification is then preferably forwarded from the retailer 20 to the program administrator 14, such as over a communicative connection 44, or by manual entry by the administrator 14, thereby allowing the program administrator 14 to correlate the positive or negative response 34 of customers 24 to specific advertisements 12 received by the consumer 24. The behavioral profile may be attached to each relevant business retailer or product, where it may then be weighted, averaged, and inserted into the consumer's behavioral profile. These correlations 50 may be sorted in any manner apparent to those skilled in the art, in order to produce reports to the at least one retailer of the effectiveness of the targeted advertisements 12, and to thereby allow for measurable marketing. Further, data scanned from the saver card is recorded into the transaction record associated with that saver card, and into a transaction record associated with that retailer, wherein each of these transaction records is maintained within the program administrator. The transaction may include, for example, entry into the retailer store, a purchase in the retailer store, or receipt of a discount in the retailer store on a purchase.

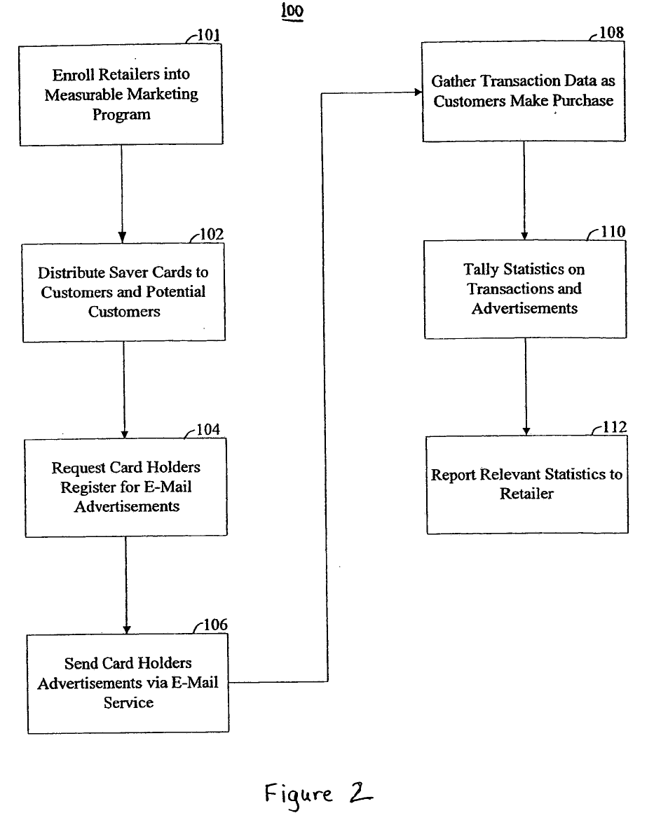

FIG. 2 is a flow diagram illustrating a method 100 of advertising, and of measuring the effectiveness of advertising. The method may include the steps of enrolling retailers into a measurable marketing program 101, distributing saver cards or other identifiers to customers and potential customers 102, requesting registration for targeted advertisements of holders of saver cards 104, sending targeted advertisements to registrants 106, monitoring purchase transactions resulting from the advertisements 108, statistical analysis of the transactions based on the advertisements 110, and the reporting of relevant statistics to the retailer 112.

At step 101, retailers may be enrolled into a measurable marketing program. In order to enroll, the retailer may, for example, pay an enrollment fee, and the retailer must additionally offer to provide value to customers through discounts, loyalty incentives or special deals available over a targeted advertising service. The enrollment fee may be, for example, a fixed price per month, such as $250, to allow for participation in the program. In the prior art, at a particular University, a local student newspaper charges $17 per square inch of advertising space per day. Therefore, an average advertisement may cost $300 for a 4″ by 5″ advertisement, per day, with no ability to measure return on the investment. The present invention thus provides improved capability to assess return on advertising investment, at a reduced cost over known advertising programs.

Suitable retailers may be assessed, or accessed, via any means known in the art, such as telephonically, via the Internet, via door-to-door sales, or the like. Suitable retailers may preferably be those retailers that are local to the customer base, or potential customer base, of the advertising system. Customers react most positively to advertisements of a business if the business or products advertised are recognizable to the consumers. Other methodologies of increasing association of the program with the local community will be apparent to those skilled in the art. The present invention is readily expandable with respect to participating retailers or participating products outside of a local community or local communities. Thus, the program may be expanded to a wide ranging audience, yet may be community-oriented in nature.

At step 102, saver cards are distributed to customers of the advertising system, and potential customers of the advertising system. A saver card may, for example, take the form of a credit card, a keychain card, or a credit card-type card, or other forms of identification that serve to identify members of the savers program, such as, but not limited to, a driver's license, bottle opener, such as a keychain bottle opener, or student identification card, or simply a barcode sticker affixed or imprinted to any existing credit card. Saver cards may be provided at no cost to the customer, or may be provided for a suitable fee to the customer. Saver cards may be provided by a business or retailer that is enrolled in the program, or may be provided by administrators of the advertising program. Alternatively, saver cards may be obtained in response to customer requests received via telephone, by the Internet, by e-mail, or by any additional means of receiving customer requests apparent to those skilled in the art. Saver cards may include thereon a methodology for data storage, such as a magnetic strip, or a radio-frequency identifier or integrated circuit memory chip. Alternatively, the saver card may have thereon printed a numeric or alphabetic key code, or a bar code, for tracking purposes of the card. Preferably, saver cards are distributed in pre-assessed markets wherein numerous of the suitable retailers or products are located proximately to the desired customer base. It will be apparent to those skilled in the art that saver cards may be distributed prior to the addition of retailers, or of new retailers, to the marketing program, or may be distributed at any point in the lifeline of the marketing program.

At step 104, customers holding the saver card may sign on to, for example, an Internet site associated with the marketing program, or an administrator thereof, in order to register as customers in the marketing program. A registration screen may be provided by the administrator of the program. In a preferred embodiment, upon registration at the web site, the customer, and the saver card of that customer, will be associated with data within the marketing program. For example, the customer holding a saver card may enter personal information to allow for association of that customer with particular interests prior to building of an overall purchase-profile for that customer, such as preliminary estimates for interests in particular retailers. For example, the customer may enter a name, a local address, a telephone number, a series of hobbies, and/or may answer a series of profile questions, such as those related to eating and/or shopping habits. It will be apparent to those skilled in the art, any number of questions may be asked of the registering customer, that at least one question, preferably provides contact information sufficient to allow targeting of advertisements to the customer by the marketing program.

At step 106, and as a result of registration in step 104, targeted messages and advertisements are forwarded to the saver card holder. In one embodiment of the present invention, e-mail messages are employed in order to forward messages containing targeted offers, or targeted advertisements, or invitations to the main web page of the program from retailers, to the saver card holders selected by those retailers as most likely to be responsive to the targeted offers for advertisements. For example, each retailer participating in the marketing program may provide a series of criteria from which customers to be associated with advertisements of that retailer are to be selected. Alternatively, retailers may provide variable criteria for the targeting of advertisement to customers, based on particular marketing efforts of the retailer.

In addition to the offering of discounts, such as special “last minute” discounts, to cardholders via e-mail, notification of deals at step 106 may be performed entirely via the website of the program administrator. The website may, for example, feature hyperlinks to businesses, such as local businesses, that offer savings on the goods and services for registered users of the website. Accessing of these hyperlinks may provide additional information regarding a promotion, or may allow for the printing of, for example, an electronic coupon associated with the hyperlinked business. A targeted offer or advertisement preferably includes an enticement, such as a discount or loyalty points award, to the saver card holder to visit the retailer, and/or select or purchase a product or service of the retailer. The targeted messages may be generated by the administrator of the marketing program, with or without the instruction of at least one participating retailer or business, or may be provided to the system directly by the retailer via, for example, Internet web site connection, e-mail, telephone, or regular mail.

At step 108, transaction data is recorded as card holders visit retailers from which targeted messages were sent. The transaction data gathered may include, for example, that the customer performed a desired task in response to the message, such as visiting the retailer, or making a purchase from the retailer. At the point that the desired transaction occurs, the saver card of the user is preferably scanned, and/or manually entered by a party located at the retailer, in order to record into the marketing program that the desired transaction, due to the targeted message, has occurred. The merchant may, for example, swipe the card in a magnetic strip or bar code reader, or manually type in the letters and/or digits of an identification number. The mechanism for reading or entering the saver card identification information may be communicatively connected to the program administrator server via, for example, a modem, intranet, or internet link. Transaction data may include, for example, the time, date, amount of transaction, item purchased, service purchased, quantity purchased, retailer involved in the purchase, identification of the purchaser, proximity of receipt of the targeted messages from that retailer to that purchaser, and/or the success rate of targeted message from that retailer to that purchaser to-date. In one embodiment of the present invention, the information regarding identification of the purchaser may not be available directly to the retailer, and may be entered into the marketing program system in an encrypted, or otherwise secured, fashion. In this manner, the privacy of the customer may be protected. Nonetheless, it is preferred that the marketing program be enabled to track the identification of specific customers.

At step 110, statistical analysis of transactions is performed. The statistical analysis of transactions may occur, for example, after a suitable number of transactions have occurred, after a suitable time period, after a single transaction, or after a suitable number of advertisements, for example. The statistical analysis preferably provides information as to the success or failure of the marketing program. The criteria for success or failure may be generated by the marketing program, or may be generated by the retailer. The statistical analysis may include a comparison of the return on investment of a given program of a retailer to other programs of that retailer, or to other programs of other retailers. Further, the statistical analysis may aid in the identification and/or targeting of particular markets, or market segments, for promotions. Thus, the success and/or probability of success of a marketing program is measurable due to the statistical analysis.

At step 112, the results of the statistical analysis are reported to the retailer. It will be apparent to those skilled in the art that either the retailer, or the administrator of the marketing program, may perform the statistical analysis and provide the report thereof to the retailer. Reports of the success, and/or failure, of marketing programs may periodically be provided, for example, in daily, weekly, monthly, quarterly, and/or yearly formats. Reports may be available to the retailer by, for example, regular mail, e-mail, or log-in and review on a web site of the administrator, or of the retailer. Alternatively, the data necessary to perform the analysis may be sent from the program administrator to the retailer, and the retailer can then correlate the data and/or formulate the reports, thereby allowing for increased specialization in the reports, and improved customer privacy due to the analysis of the data by fewer parties. In this alternative embodiment, the reading of the saver card may be linked directly to, for example, an on-site computer that performs data collection.

Upon correlation of specific advertisements and cardholder reaction, the success ratio of advertisements, or types of advertisements, may be gauged. The number of cardholders responding to the program at the specific business may be compared to the cost of advertisement, and a metric of business generated per dollar of advertising dollar may be thereby ascertained. In general, it is noted that the reports generated reflect that the stream of revenue from the marketing program of the present invention, correlated with the advertising costs, is substantially constant, due to the fact that the program of the present invention is not based on the number of hits on the website, or daily fluctuations in newspaper readership, for example.

The method of the present invention may additionally include, within the step of forwarding advertising to cardholders, the step of forwarding surveys to cardholders. These surveys may assist retailers and/or the program administrator in gaining desired information, such as information that improves the success of future promotions. Cardholders that complete the survey may receive a reward, such as a special, limited promotional message.

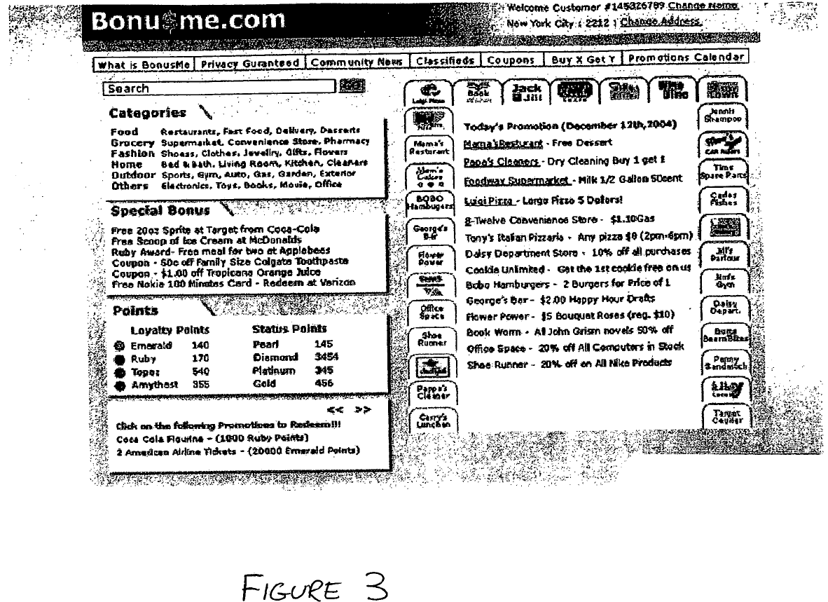

Thus, the present invention may be used to incorporate limited time value-based promotions or coupons for retail, product and service businesses into a community-oriented website. As shown in FIG. 3, consumers may be exposed to a variety of options when determining where and how to make a purchase. Consumers may go to the central website location managed by the administrator to find product promotions that peak their interests at businesses in their local community.

The central website discussed hereinabove may require a membership to the saving or marketing program, for a fee or free of charge, for establishing the account that allows recognition of selection of promotions or coupons, awarding of loyalty points, and subsequent redemption or awardance of any savings benefits upon completing a purchasing transaction. When a consumer views an establishment that meets her purchasing needs, or when the consumer finds a promotion or coupon that caters to her needs, she may simply select the applicable promotion or coupon by adding it to her account, and may physically or electronically go to the retail or local business establishment. Upon selection of products or services for purchase, the consumer may scan her unique identification associated with her membership account.

The consumer may access the central website through completion of an account login page, such that specialized discounts, accrued loyalty points and other offers targeted to that particular consumer may be visualized. Upon successful login, the user may access the central website, which may provide standard features typically found within interactive websites, such as searching, site index, administrator contact information, help information, website tutorials, and the like. As depicted in FIG. 3, other features selectable from the central website may include Privacy Guarantees, Community News, Classifieds, Coupons, Special Offers, such as Buy X Get Y, and Promotional Calendars, which may be based on any selected timeframe, such as daily, weekly, or monthly. Other features of the website may include Special Bonuses, where businesses may list particular discounts targeted specifically to the viewing consumer. The central website may use any format, layout or organizational system available to a website developer or administrator.

Additionally, the consumer may choose to always show or never show business promotions, or any combination of showing and not showing promotions from any particular retailer or retailers.

The website may list selectable features by Categories, such categories including, for example, Food, Grocery, Fashion, Home, Outdoor, and Other. Further subcategories may also be selectable, such as under the Food category, subcategories might include Restaurants, Fast Food, Delivery, and Desserts, for example. Additionally, when a keyword is searched, relevant matching keywords found in the individual webpages of the business may allow display of those businesses within newly formed categories. For example, if Sushi is entered, the Garden and Outdoor categories may disappear, but Supermarket, Fast Food, and Restaurant may still remain because there are businesses within them that have sushi as a searchable keyword. When those categories are clicked, they may only show businesses that contain the relevant keyword instead of all businesses in the category.

The website may feature a Points section, where at least one loyalty point system may be viewed, and may inform or update a particular viewing consumer of her current status within the applicable loyalty point systems, such as the number of points within each tier of a multi-tiered point system that have been accrued by the consumer.

The website may also include a list of participating businesses or retailers, which may be viewable as a text-based list, tabbed format, or any other mechanism known by those skilled in the art. The participating businesses list may also be arranged such that the businesses may form a perimeter around another promotions offer section selectable by the consumer. This particular layout may allow a consumer, when selecting a particular retailer, to have that particular retailer's promotional offer appear inside the perimeter of the participating retailers list.

Any promotional, coupon or other savings related material may be placed by participating businesses into targeted consumers' customized webpage via administration of the website by the program administrator. Such promotional and other related material may be accessible to the consumer through initial selection by the consumer, such as a selectable hyperlink, or via a pop-up window or other internet advertising technique as will be known by those having ordinary skill in the art. Value-added emails containing personalized value promotions or invitations back to the website may also be sent to the consumers with our without their request. Preferably, retrieval of promotional related material by the consumer may be a proactive instead of a reactive, so that the consumer may not feel irritated with or bombarded by unwanted information.

Traditional advertising has employed a “one size fits all” brand awareness approach. In reality, consumer purchasing behaviors are driven and influenced by various factors, such as price, quantity, quality, novelty, repetition, brand, and impulse. Current methods of advertising do not establish a one-to-one relationship with the consumers to take advantage of motivating traits to drive them to the point of sale. Often, surveys are conducted to gauge what the consumer's preferences are. This includes basic demographics information, personal interests, and other predictive data. However, the way consumers characterize themselves is not a foolproof representation of their actual behavior. This type of information is speculative and based on images people have of themselves and those around them, and not based on what they actually do or purchase. Thus, today's demographic and interest measurements do not truly reflect actual buying behaviors.

Consumer analysis companies often use point of sale registers of credit card actions in correlating consumer purchasing behaviors and habits, rather than relying on consumers' self-characterizations. However, duplication of consumer names and consumer tendencies to make purchases with more than one credit card often compromise such data. After gathering data, such companies may work with other institutions to find relevant contact information for consumers. This methodology produces large amounts of piecemeal data, much of which is not relevant, and all of which is at a very high financial cost to the retailer requesting the information. Also, this process brings issues of consumer privacy rights into play, which frequently places the consumers on the defensive.

Buying behavior monitoring and inducement to purchase is thus best done through actual purchases at the point of sale. The present invention may establish a pre-built behavioral and motivational factors rating system that may be associated with every product or business on a common platform. For example, for every consumer who conducts a transaction, a generic code, which may be product or business related, may be correlated, weighted, and calculated into that consumer's profile. This rating system may be a stand-alone technology that may be linked with any credit card, saver card, or other item capable of uniquely identifying the consumer and linking that consumer to a transaction. Profiles may continuously be updated as new purchases or transactions occur, which may create a real-time behavioral profile reflective of a consumer's current purchasing tendencies. Thus, these real time profiles track across business and transaction types, thus allowing for the creation of a more refined consumer profile (e.g. while going to a movie theater and renting a movie may be related actions, renting a movie and going to the dry cleaner may not be related actions, but rather may be geographically linked). These real-time profiles may also be used as a measure of predicting actual purchasing patterns, such as seasonal patterns, purchasing patterns within the month, or even daily purchasing patterns. Businesses may then use these profiles to determine when the best time to send promotions or coupons to particular consumers, and thus maximize their advertising and marketing efforts.

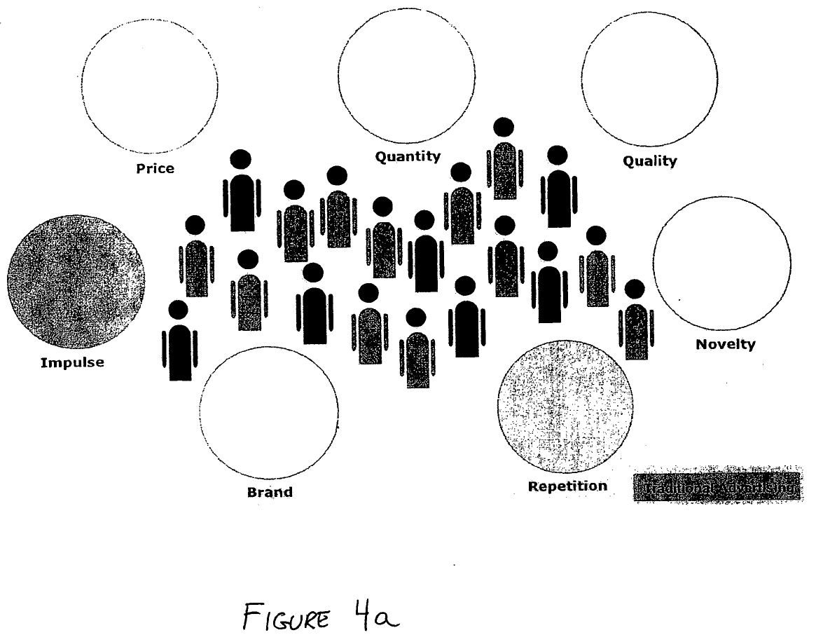

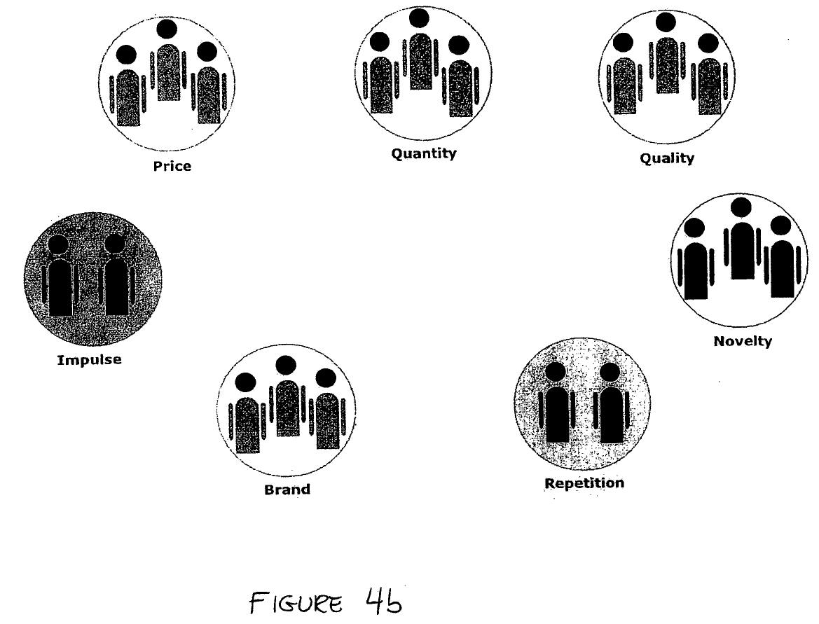

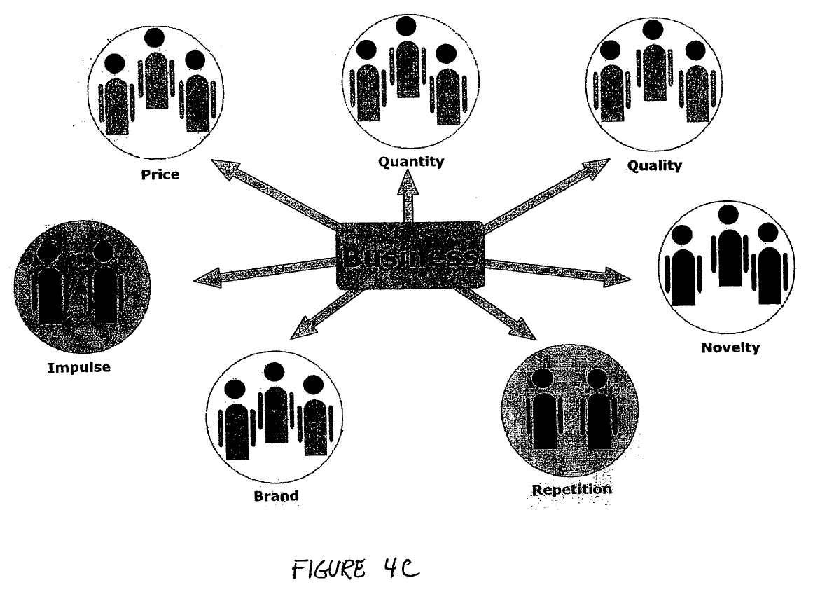

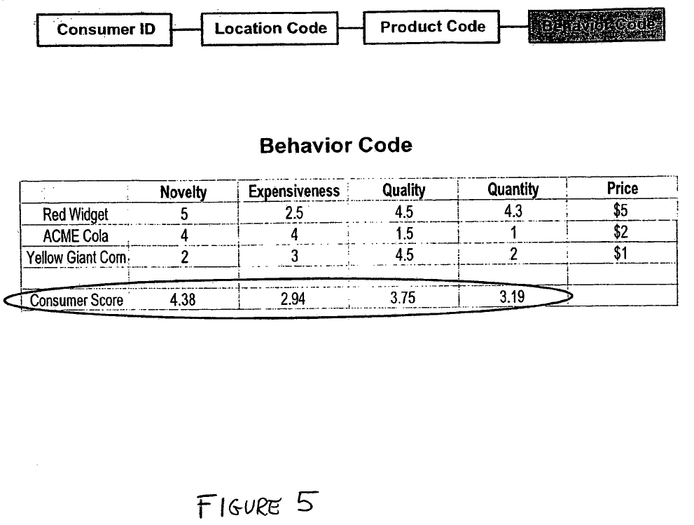

As may be seen in FIGS. 4a to 4c, behavioral traits may be incorporated into a behavioral rating system, including, for example, such traits as responsiveness to price, quantity, quality, novelty, repetition, brand, and impulse. Any number and type of behavioral traits may be incorporated into the rating system, such that the traits may be related or reflective of consumer purchasing behavior. Preferably, the number and type of traits used may be sufficient to successfully segregate consumer behaviors such that a business can distinguish many purchasing profiles and target those profiles most valuable to that business. These traits may be assessed on a scale and associated with each product or service item. For example, as illustrated in FIG. 5, in a system which scales each behavioral trait from one to five, a red widget may be a new product in the market, and thus may be given a value of five for novelty. It may also cost between $5 and $10, which may carry a value of 2.5 for expensiveness. The red widget may be of superb quality compared to similar widgets on the market, and thus may be given a 4.5 for quality. Also, if the red widgets come in packs of ten, which may be considered a family-sized package, the quantity may be scored as a 4.3. As may be understood by those skilled in the art, any scaling technique may be used by the behavioral rating system without departing from the spirit of the present invention.

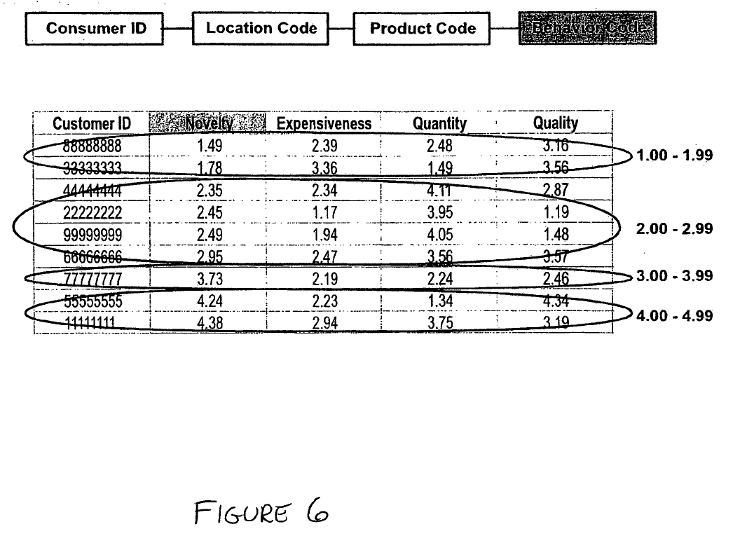

After a consumer purchases a product, the behavior scores linked to that product may be added, averaged, and weighted in any statistical manner by the program administrator or as requested by particular businesses or retailers. For example, as illustrated in FIG. 6, similar ranges of behavioral scores may be grouped together, or bounds of ranges may be dynamically adjusted. As the consumer continues to make purchases, the behavior rating system data may be compiled into a purchasing profile unique to a particular customer, and thereby indicating the behavioral driving factors of that consumer to purchase. As may be understood by those skilled in the art, such a purchasing profile as described above may be significantly more accurate in predicting future purchasing needs than prior art systems, in part because the system may be tailored to individual consumers, and based on actual purchasing behavior, rather than generic demographics which are not directly linked to sales of products.

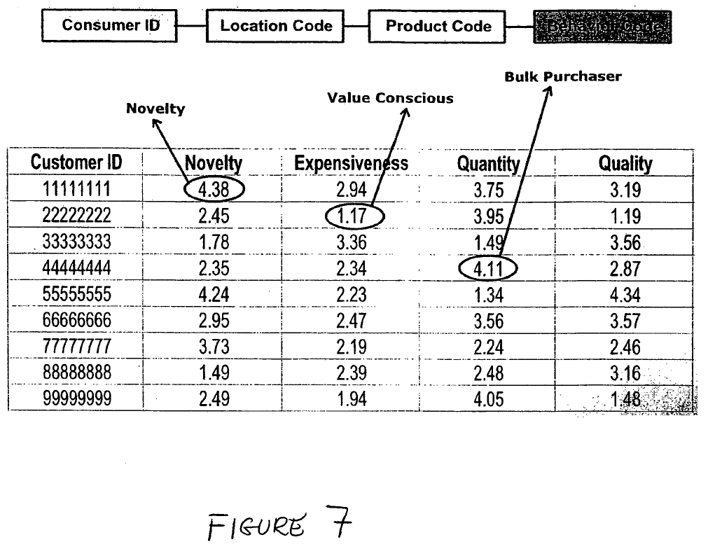

In another embodiment of the present invention, the behavioral purchasing profile data may be used by companies to better recognize the traits of their customers and to further maximize their marketing efforts. For example, as illustrated in FIG. 7, companies wishing to target consumers with specific behaviors, such as Bulk Purchasers, Value Conscious Purchasers and Purchasers who go for the “newest thing” available, may obtain the behavioral purchasing profiles to identify and locate individual consumers or consumer groups. In another example, businesses may conduct general queries for such data. The present invention may further identify all consumers who have purchased from a specific business client through the queuing of loyalty points or promotions. For existing usage consumers, queries may also be conducted into the frequency of purchase for the specific business client.

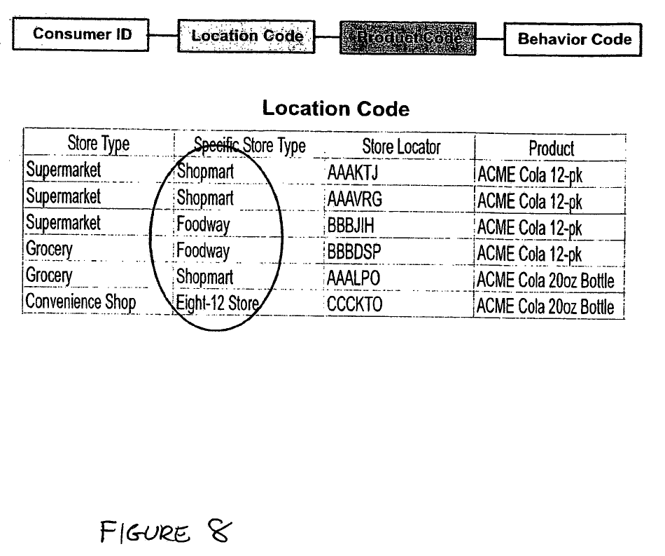

In other instances, information regarding where the consumer purchases a product or service may be relevant to businesses that have more than one distribution outlet. Association of retail establishments within consumer purchasing behavior may also allow consumer purchasing locations to be analyzed. For example, as illustrated in FIG. 8, similar products and services may be compared across various price continuums of various locations. As may be understood by those of ordinary skilled in the art, any data linked to a purchase, such as purchase price, product promotion or coupon usage, location of purchase, time of purchase, and any combination of such data, may be incorporated into the behavioral purchasing profiles and used by businesses to maximize their marketing efforts.

One such marketing effort capable of optimization through the use of the present invention is the use of coupons. Coupons typically involve printing coupons from the internet and using them at the point of sale. Internet coupons save companies the costs associated in printing coupons or the outsourcing printing costs. However, this strategy only targets a subset of consumers who use coupons frequently. These consumers are often dedicated “bargain hunters, and as such may not be a desirable target demographic for retailers, and further such consumers often repeat usage of the same coupons, continuously discounting the products and thus reducing profits for the seller.

The present invention increases the pool of coupon users to include more desirable consumers and eliminates repetitive coupon usage by providing promotions which may be redeemed discreetly through scanning the unique identifier saver card, and by electronically limiting the number of coupons available to any given consumer.

In an embodiment of the present invention, a “one click coupon” system may control the time and frequency of a coupon offer to a consumer, and subsequent redemption of the coupon. By incorporating the behavioral purchasing rating system discussed hereinabove with the one click coupon technology, the behavioral purchasing profiles may further identify consumers driven solely by coupon usage or pricing discounts through promotional redemptions. Thus, businesses can avoid spending targeted advertising dollars on such undesirable consumers. Such data may also be used by businesses to recognize long term loyal customers and not merely discount oriented, short term consumers.

As mentioned earlier, traditional coupon systems allow the coupons to be used over and over again, which may reduce product profitability. Also, traditional coupons are a burden to deal with, easy to lose, and portray a “low budget” image for a product as well as for the consumer. However, the present invention may present an image that focuses on promotions in the form of appreciation from the retailers. Additionally, expenses associated with the printing of coupons may be eliminated for both the retailer and the consumer alike.

Electronic coupons which may be offered and redeemed electronically may eliminate expenses associated with printing coupons because all stages involving a physical printed material may be eliminated. Also, because the present invention may create data associated with the offer of a coupon and the redemption of a coupon in a purchase transaction, coupon usage may be linked directly to particular consumers or consumer groups and incorporated into their behavioral purchasing profiles. This type of targeted data may inform businesses which coupons drive traffic into specific stores, and subsequently teach businesses which coupons are effective and with which consumers or consumer groups those coupons are effective.

Referring again to FIG. 3, the consumer may select a coupon generally from the central website from the Coupon section for addition to that consumer's account, or the consumer may select a retailer from the list of participating retailers, which may then produce a selectable coupon that may be added to the consumer's account. The retailer may offer any number of coupons, and may allow a consumer to add any number of coupons to her account. It may be more profitable to allow addition of only one coupon per consumer from the retailer, as the strategy of offering coupons is to entice the consumer into the store at a minimal cost to profitability. Thus, allowing multiple coupons per retailer may dilute the effectiveness of any particular coupon.

After addition of the coupon uniquely to that consumer's saver account, the ability to access the coupon from the website may be deactivated for a login from that consumer's account, and the coupon may be added to the information accessible for that consumer in association with her saver card. Upon scanning the unique identifier card at the point of sale, the coupon discount may be applied discreetly and shown on the register receipt. The discount may then be recorded in the transaction and added into that consumer's purchasing profile. Further, other items purchased during the same transaction may be recognized, thus providing the retailer with information of what sales and other purchase types were generated directly and indirectly from the redemption of the coupon. Also, upon that consumer's next purchasing visit to the retailer, the tracking system may reveal whether the previously coupon-discounted product was purchased again, without a discount, as well as the frequency of such non-discounted future purchases. Retailers may then recognize when a consumer has stopped purchasing a particular item, or when greater lapses of time occur between purchases of a particular item. Such recognition may allow a retailer to identify current loyalty levels of particular consumers, and make future coupon offers when deemed necessary.

In the prior art, the same generic promotion or coupon is sent to and accessible by all individuals subject to a mailing list. Such a system requires a generic and generalized format because it is too costly and inefficient to send individualized promotions to particular consumers. Businesses have recently discovered how to track online purchasing behaviors, through data such as frequency of shopping and items purchased, etc., and thus have made a tiered offerings system for consumers who have purchased certain items or responded to queries that they have certain interests toward a specific category of products. In order for these strategies to work, every aspect of the purchasing transaction and data collecting information must occur or be tracked online.

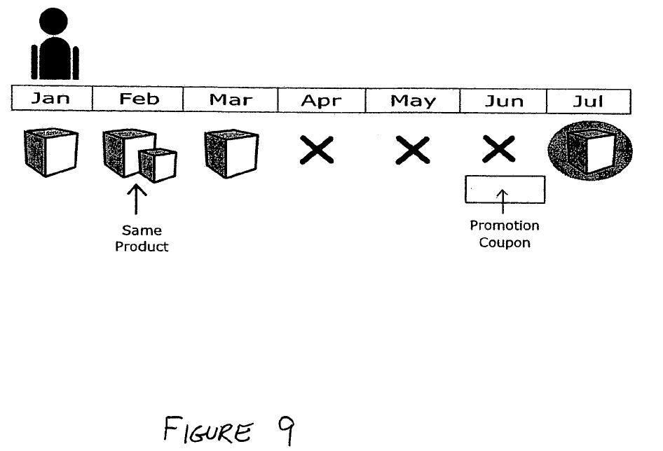

The present invention may provide not only these basic tracking systems, but also the tracking of actual offline purchases by the consumer, and may gauge whether or not a particular consumer or consumer group needs an individualized promotion. Instead of advertising and promoting to all consumers, the present invention may allow businesses to choose specific behavioral patterns, which may be based on the provided behavioral purchasing profiles, they wish to target. Thus, promotional material may be sent to any consumer or combination of consumers to maximize marking efficiency. For example, as illustrated in FIG. 9, when a consumer has not visited a particular retailer for three months, after visiting that retailer every month for multiple months prior to the lapse in the purchasing pattern, the retailer may send a promotion specifically to that consumer or consumer group exhibiting the targeted behavior. This may provide a business with the ability to take a proactive approach to retain or obtain loyal, longer term customers.

In another example, a business may identify that loyal consumers to their brand have buying characteristics fitting a particular behavioral purchasing profile. They may then query the database for all consumers that may not currently be part of their purchasing consumer base who display the same characteristics, or behavioral purchasing profile, as those within their purchasing consumer base. Thus, the business has targeted those customers from the general consumer public most likely to become loyal customers without wasting time and costs on advertising or marketing to the general consumer market. By advertising only to those consumer having particular purchasing profiles, businesses may be much more likely to gain new market share. Also, advertising efficiency may be maximized by providing promotions only to a select group of consumers displaying traits deemed valuable to the business.

The most desirable consumers are also those consumers that businesses desire to capture the loyalty of. Typical loyalty programs involve systems where consumers can be tracked by their purchases and awarded loyalty points which are later redeemed for gifts of their choice. Such systems protect the privacy of the consumers by not releasing personal contacting information to outside vendors. However, consumers for these loyalty programs typically only earn points for online purchasers or a subset of purchases that include those that can be tracked by the loyalty program (e.g. only those purchases made using a particular credit card, for example). Other points can also be earned through records affiliated with a credit card, but points accrued this way create only a single generic point earning system.

In an embodiment of the present invention, a loyalty point awarding system is provided. Loyalty points may be earned for individual vendors or through a shared loyalty program. For shared loyalty point alliances, standard groups with predetermined exchange values, such as monetary values, may be formed. Referring again to FIG. 3, two loyalty systems may be provided to consumers. As should be understood by those having ordinary skill in the art, any existing loyalty point system, as well as any number of differentiating loyalty point systems, may be incorporated or used in combination with that of the present invention. For example, as illustrated in FIG. 3, a Points system may include a Loyalty Points and Status Points award programs.

In the example of FIG. 3, the Loyalty Points program may be a monetary based system, whereas the Status Points program may be a quality based program. The Loyalty Points program may include multiple tiers, or levels of reward points, such as, for example, Emerald, Ruby, Topaz and Amethyst. Loyalty points may have variable value, such as a higher tier having points that may provide more value to a consumer than points from a lower tier. As will be understood by those skilled in the art, any number of tiers may be used within the present invention. Businesses, when participating in the Loyalty Points program, may choose to award loyalty points in any of the tiers. The business may be required to pay a higher cost to award points in a higher tier, and a lower cost for lower tiers. The Status point program may function in a way similar to the Loyalty Points program, but the value obtained by the consumer may be related to a non-monetary, prestige redemption program. For example, when a consumer reaches a certain threshold of status points, they may receive special treatment from the vendor for their continued loyalty.

A tiered loyalty program may increase competition between businesses, markets or groups of companies, and may boost incentives to award and retain loyalty. Because this competitive multiple shared loyalty program may be conducted on one common platform, consumers may apply their awarded points in more ways and with more businesses. For example, when the unique identification card is scanned by the consumer, he/she may receive X number of points toward loyalty tier A for purchasing a specific product, and Y number of points toward group B for purchasing a second, but different product, which may be a rival product. The consumer may also use the same identification card to earn points toward group A at various other partner businesses, and again may use the same card to earn points for group B at businesses that rival those in group A. This common platform loyalty program may provide the ability to combine points for products and business establishments with one easy redemption system that may create competition within the platform. Also, the redemption process may be completed through any other feature selectable via the central website, such as the awarding of additional discounts, promotions or gifts that may be received upon the consumer's next visit to a particular establishment, or may be received via the mail, for example. Companies may also use mechanisms to control redemption of awards by promoting new products or attempting to clear out inventory. Further, the loyalty point systems utilized within the present invention may also generate traceable data for incorporation into the aforementioned purchasing profiles of consumers, thereby increasing the power of such profiling data to maximize marketing efforts.

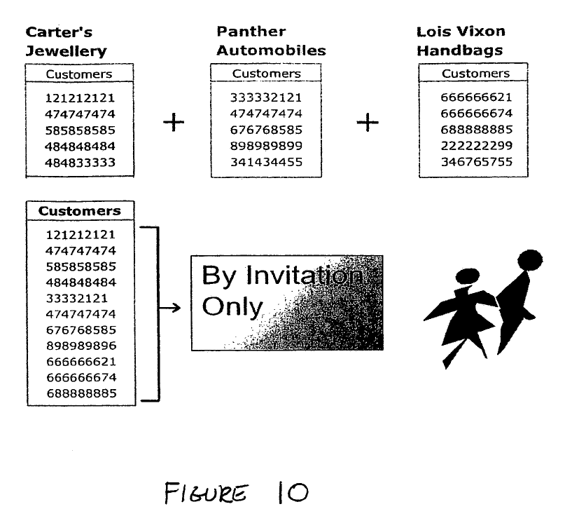

An accrued loyalty or status point value can be applied towards any offering from the various partner businesses for redemption. For example, as illustrated in FIG. 10, retailers for jewelry, automobiles and handbags, respectively, may create an alliance in a Point program, whereby select customers from these three pools of consumers are awarded a gift or discount via invitation only. Thus, the ability to choose between different alliances may allow competing businesses to prompt consumers to accumulate points for their specific alliance.

As such, and in differentiation from loyalty points, status points may be emblematic of an engagement by a consumer in a high margin transaction, such as for expensive and/or prestigious goods. Therefore, not only may consumers participate in special promotions or events based on accumulation of status points, but access to consumers generating many status points is inherently access to the most desirable consumers, and thus access to such consumers might bring a premium payment from a business desiring to access consumer listings.

Thus, loyalty points or status points may be used to create business alliances. In typically prior art applications, such alliances typically purchase a point allotment from a redemption broker. However, by the use of the present invention, points are purchased from the program administrator by each participant business for distribution to consumers accessing that business, and those distributed points are redeemed directly by that consumer for goods or services, and the monetary equivalent of the goods or services accessed using the points is paid out to the business at which the access occurred by the program administrator.

Each aspect of the present invention may be used to provide in-retailer advertising. For example, participating retailers may provide an advertising mechanism in-store, such as a scrolling billboard or electronic display screen. Advertising may be generated, such as remotely from the program administrator via a batch download to the retailer or via a streaming process, to the advertising mechanism.

The advertising may be generated in still frames, flash technology, or in streamed video, and each advertisement may be assigned into a series of “frames” of a predetermined size. For example, each minute of in-store advertising may be broken into 15 second slots, allotted as frames 1 through 4. Each frame may have an assigned ad, or an assigned ad type, and the ads displayed may be displayed in accordance with a plurality of display rules. For example, competitor retailers may not be displayed, or multiple products, each competing in the same product category, may not be displayed in close proximity. Further, certain frames may be allotted for local participant ads, while others may be at the discretion of the program administrator. Advertisers may pay on a per frame display basis, or may pay for display at certain times of day, or on certain days, or choose the length between each advertisement display, or may pay for display in certain high-traffic locations, for example. Businesses may also choose what location and/or category of businesses to display the advertisement in. For example, a soft drink company advertising Product A may display at all Chinese restaurants with a relevant ad that says “Product A is great with Chinese food”.

Businesses may also create shared advertising plans or alliances, where businesses swap advertising slots between each participating business. Such shared advertising plans may increase the effectiveness of sales through such cross-promotion marketing strategies. Agreements for such shared plans may incorporate any number of businesses, and share or swap advertising slots in any number and manner agreeable to the participating businesses.

Additionally, ads displayed may be modified according to a purchaser then present at the display, such as a purchaser presence indicated by a recent use of a saver card. In such an embodiment, available ads may be compared to the profile of the purchaser present, and the ads displayed may be corresponded to matches in the target profile of the purchaser present.

Advertising not purchased or selected may be made available for alternative purchase, such as by non-member advertisers, or such as at a bulk rate. Further, ads purchased at the bulk rate may be periodically filled in to eliminate empty ad frames, for example.

Those of ordinary skill in the art may recognize that many modifications and variations of the present invention may be implemented without departing from the spirit or scope of the invention. Thus, it is intended that the present invention covers the modifications and variations of this invention provided they come within the scope of the appended claims and their equivalents.

1. A method for providing at least one targeted local marketing program and for measuring the effectiveness of the at least one targeted local marketing program, said method comprising:
generating at least one targeted message in accordance with instructions of at least one retailer;
forwarding said at least one targeted message to a plurality of select customers; and,
monitoring responses from said plurality of select customers via an identification methodology, said monitoring allowing for a determination of the effectiveness of said at least one marketing program,
wherein said targeted messages attract customers to retailers by targeting said plurality of select customers with incentives.

2. The method of claim 1, wherein said at least one targeted message is an email.

3. The method of claim 1, wherein said plurality of select customers includes customers who have expressed a willingness to be in the program.

4. The method of claim 1, wherein said plurality of select customers is based upon a target criteria of at least one retailer.

5. The method of claim 1, wherein responses comprises responses to messages.

6. The method of claim 1, wherein responses comprises interaction with a retailer.

7. The method of claim 1, wherein responses comprises registering for a program by at least one of initiating a profile or varying profile information.

8. The method of claim 1, wherein said identification methodology includes a saver card.

9. The method of claim 1, wherein said incentives include at least one of discounts, sales, promotions, and incentives.

10. The method of claim 1, wherein said targeted messages include at least one of email, telephone call, internet message, mobile telephone message, PDA messaging, or messages included in communication overhead.

11. The method of claim 1, wherein said generating at least one targeted message is performed by a program administrator.

12. The method of claim 1, wherein said targeted messages include invitations to a web page.

13. The method of claim 1, wherein said instructions include the formulation of advertising.

14. The method of claim 1, wherein said instructions include the criteria for selecting said plurality of select customers.

15. The method of claim 1, wherein said instructions include the content of the advertisement.

16. The method of claim 1, wherein said at least one targeted message is generated about one per day.

17. The method of claim 1, wherein said at least one targeted message is generated about one per week.

18. The method of claim 1, wherein said forwarding is determined based upon a comparison of the target criteria in the instructions of at least one retailer to the accumulated profile information.

19. The method of claim 18, wherein said accumulated profile information includes a target history of a plurality of the customers.

20. The method of claim 18, wherein said target criteria includes the buying history of the consumer.

21. The method of claim 1, further comprising maintaining a relational database of profile information of each of said plurality of select customers,

22. The method of claim 21, wherein said maintaining a relational database is performed by an administrator.

23. The method of claim 21, further comprising recording said monitored responses in said maintained relational database.

24. The method of claim 23, wherein said recording includes an identification of the customer associated with the profile of that customer.

25. The method of claim 1, further comprising enrolling retailers into said at least one targeted local marketing program.

26. The method of claim 25, wherein said enrolling includes payment of an enrollment fee.

27. The method of claim 25, wherein said enrolling includes offering to provide value to said plurality of select customers through incentives.

28. The method of claim 1, further comprising distributing said identification methodology.

29. The method of claim 1, further comprising requesting registration for targeted messages of said select customers via said identification methodology.

30. The method of claim 1, further comprising performing a statistical analysis of said monitored responses.

31. The method of claim 30, further comprising reporting the relevant statistics identified in said statistical analysis.

32. The method of claim 31, wherein said relevant statistics provide information related to the success of the marketing program.

33. The method of claim 31, wherein said relevant statistics aid in the targeting of customers for future incentives.

34. The method of claim 1, further comprising building of an overall purchase-profile for at least one of said plurality of select customers.

35. The method of claim 1, further comprising managing said at least targeted local marketing program with a central website location.

36. The method of claim 35, wherein one of said select plurality of customers selects an incentive of interest.

37. The method of claim 36, wherein said selecting an incentive of interest adds the incentive to said one of said select plurality of customers account.

38. The method of claim 37, wherein upon selection of products for purchase, said one of said select plurality of customers scans said identification methodology to thereby redeem said selected incentive.

39. The method of claim 35, wherein said central website location displays particular discounts targeted specifically to the viewing consumer.

40. The method of claim 35, wherein said central website location displays at least one coupon targeted specifically to the viewing consumer.

41. The method of claim 1, further comprising accruing loyalty points based on the responses of at least one of said select customers.

42. The method of claim 1, further comprising establishing a pre-built behavioral and motivational factors rating system associated with every product or business within the marketing system.

43. The method of claim 42, wherein said factors are updated as new purchases or transactions occur thereby reflecting a consumer's current purchasing tendencies.

44. The method of claim 42, wherein said factors form the basis for determining the best time to send incentives to particular consumers in order to maximize advertising and marketing efforts.

45. The method of claim 42, wherein said behavioral factors include at least one of responsiveness to price, quantity, quality, novelty, repetition, brand, and impulse.

46. A method of providing targeted incentives to at least one consumer, said method comprising:
providing a one-click coupon for at least one specific product to at least one select consumer based on a behavioral purchasing rating system and instructions from at least one retailer;
updating said at least one select customer account based on said at least one select customer interaction with said provided on-click coupon;
discounting said at least one specific product when said at least one select customer purchases said product at said at least one retailer upon said customer providing account information to said retailer.

47. The method of claim 46, wherein said providing account information includes scanning a bar code.

48. The method of claim 46, wherein said one-click coupon is paperless.

49. The method of claim 46, wherein said providing a one-click coupon for at least one specific product to at least one select consumer based on a behavioral purchasing rating system and instructions from at least one retailer is designed to recognize long term loyal customers.

50. The method of claim 46, wherein using said provided one-click coupon is monitored to determine the efficiency of the retailer efforts.

51. The method of claim 46, wherein said providing a one-click coupon for at least one specific product to at least one select consumer based on a behavioral purchasing rating system and instructions from at least one retailer is provided within a list of available one-click coupons for selection by said at least one select customer.

52. A method for providing a loyalty based reward program, said method comprising:
establishing at least one loyalty program containing at least one customer and one retailer;
providing at least one tier within each of said at least one loyalty program, wherein each tier provides a unique value within the loyalty reward program;
accounting for predetermined values of loyalty points based on products purchased according to said tier system;
providing at least one point of retail for redemption of said accounted loyalty points.

53. The method of claim 52, wherein said redemption is monetary based.

54. The method of claim 52, wherein said redemption is non-monetary based.

55. The method of claim 52, wherein said redemption is at least one of monetary or non-monetary based.

56. A system for locally presenting information generated at a remote administrator, comprising:
a local display unit, having associated therewith at least one memory cache;
a plurality of information associated with a memory unit at the remote administrator; and
a selector, wherein, based on a location of the local display unit, ones of the plurality of information are selected from the memory unit at the remote administrator for exclusion from forwarding from the memory unit to the cache;
wherein ones of the plurality of information for inclusion from forwarding are selected by said selector and are forwarded, by said selector, from the memory unit to the cache for assignment to predetermined frames of the cache for display on said local display unit in accordance with an order of the predetermined frames.
